(19) United States
(12) Patent Application Publication
(10) Pub. No.: US 2007/0292313 A1
(43) Pub. Date: Dec. 20, 2007

(54) Liquid dispensing mechanism for synchronously dispensing common liquid and specific liquid

(75) Inventors: Yi-Lung Lee, Taichung County (TW); Chin-Sung Lin, Taichung County (TW); Zhen-Hua Chou, Hualien County (TW)

Correspondence Address: BROWDY AND NEIMARK, P.L.L.C.;624 NINTH STREET, NW, SUITE 300, WASHINGTON, DC, 20001-5303, US

(73) Assignee: Antera Biotech Corp, Taichung City (TW)

(21) Appl. No.: 11/699,437

(22) Filed: Jan. 30, 2007

(30) Foreign Application Priority Data
Jun. 15, 2006 (TW) 95121494

(51) Int. Cl. B01L 3/02

(52) U.S. Cl. 422/100

(57) ABSTRACT

A liquid dispensing mechanism for synchronously dispensing a common liquid and a specific liquid used in a biochemical analyzer includes a coupler having a first coupling hole, a liquid outlet, a connecting tunnel connected between the first coupling hole and the liquid outlet, a second coupling hole, and a common liquid passage connected between the second coupling hole and the connecting tunnel, a specific liquid dispensing syringe insertable into the first coupling hole of the coupler for out dispensing the contained specific liquid through the liquid outlet, and a common liquid dispensing syringe having a liquid inlet connected with a common liquid source. The common liquid dispensing syringe is insertable into the second coupling hole of the coupler for dispensing the common liquid into the common liquid passage and out of the coupler through the liquid outlet of the coupler together with the specific liquid.

### BACKGROUND OF THE INVENTION

1. Field of the Invention

The present invention relates generally to biochemical analyzers and more specifically, to a mechanism for use in a biochemical analyzer for synchronously dispensing a common liquid reagent and a specific liquid reagent into a reagent reaction container.

2. Description of the Related Art

A biochemical analyzer for mixing different liquid reagents is known having a plurality of specific liquid dispensing syringes respectively filled with a specific reagent and carried on a rotating table. The specific liquid dispensing syringes are carried by the rotating table one after another to dispense the respective reagent to everyone of a number of reagent reaction containers during rotation of the rotating table step by step by a step motor.

During dispensing of different reagents to every reagent reaction container by the specific liquid dispensing syringes, a common liquid, for example the catalyst solution, may have to be dispensed to every reagent reaction container. A common liquid dispensing syringe is used to dispense the common liquid to the reagent reaction containers one after another. This common liquid dispensing procedure is complicated, requiring much time and labor. Thus, the performance efficiency of the biochemical analyzer is relatively lowered.

### SUMMARY OF THE INVENTION

The present invention has been accomplished under the circumstances in view. It is one objective of the present invention to provide a liquid dispensing mechanism, which is controllable to dispense a common liquid to a reagent reaction container synchronously during dispensing of a specific liquid to the reagent reaction container.

To achieve this objective of the present invention, the liquid dispensing mechanism used in a biochemical analyzer for synchronously dispensing a common liquid and a specific liquid comprises a coupler, a specific liquid dispensing syringe and a common liquid dispensing syringe. The coupler having a first coupling hole, a liquid outlet, a connecting tunnel connected between the first coupling hole and the liquid outlet, a second coupling hole, and a common liquid passage connected between the second coupling hole and the connecting tunnel. The specific liquid dispensing syringe is insertable into the first coupling hole of the coupler for out dispensing the contained specific liquid through the liquid outlet. The common liquid dispensing syringe has a liquid inlet connected with a common liquid source. The common liquid dispensing syringe is insertable into the second coupling hole of the coupler for dispensing the common liquid into the common liquid passage and out of the coupler through the liquid outlet of the coupler together with the specific liquid.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic drawing showing a liquid dispensing mechanism used in a biochemical analyzer according to a preferred embodiment of the present invention;

FIG. 2 is a sectional view of the coupler of the liquid dispensing mechanism according to the preferred embodiment of the present invention;

FIG. 3 is a schematic drawing, showing that the specific liquid dispensing syringe and the common liquid dispensing syringe are coupled to the coupler, and

FIG. 4 is a sectional view in an enlarged scale of a part of FIG. 3.

### DETAILED DESCRIPTION OF THE INVENTION

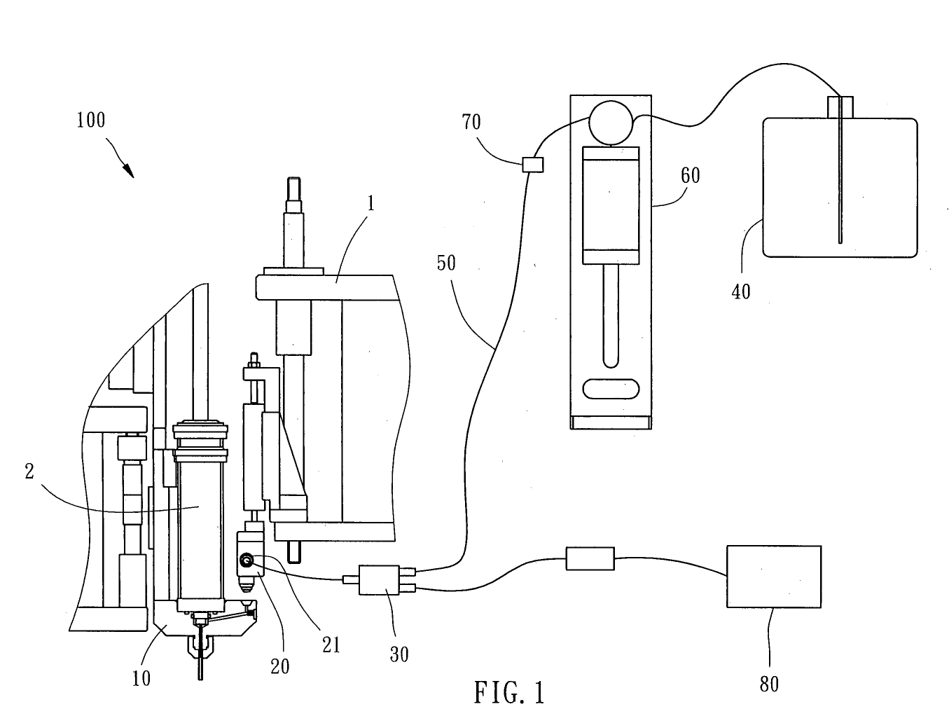

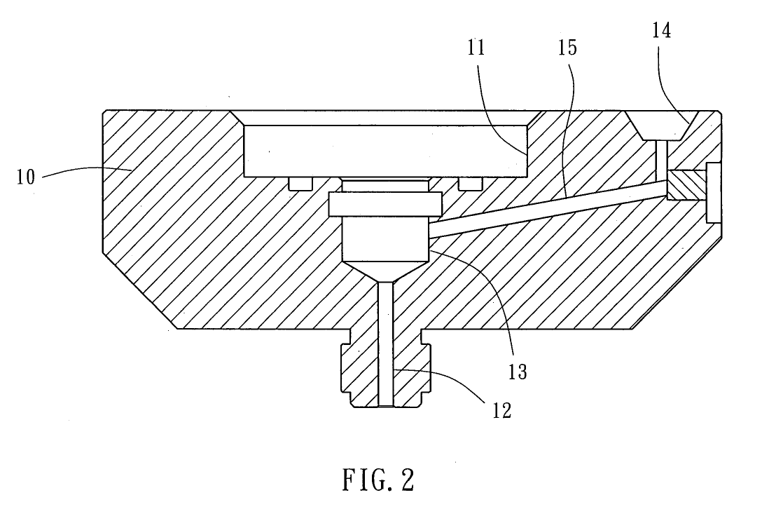

As shown in FIGS. 1 and 2, a liquid dispensing mechanism 100 in accordance with a preferred embodiment of the present invention comprises a coupler 10, a common liquid dispensing syringe 20, a switching valve 30, a common liquid container 40, a liquid conveying channel 50, a power unit 60, a sensor 70, and a compressed air source 80.

The coupler 10 is fixedly mounted on a biochemical analyzer's base (not shown), having a first coupling hole 11 extending downwards from the center of the top side thereof to a predetermined depth, a liquid outlet 12 vertically extending upwards from the center of the bottom side thereof to a predetermined depth, a connecting tunnel 13 integrally connected between the first coupling hole 11 and the liquid outlet 12, a tapered second coupling hole 14 formed on the top side beside the first coupling hole 11, and a common liquid passage 15 integrally connected between the tapered second coupling hole 14 and the connecting tunnel 13. Further, rubber seal rings 16, 17 and 18 can be respectively received in the spaces formed respectively on the bottom of the first coupling hole 11, the periphery wall of the connecting tunnel 13 and the bottom portion of the second coupling hole 14.

The common liquid dispensing syringe 20 is mounted on a moveable rack 1 of the biochemical analyzer above the coupler 10 and controllable to move up and down. The syringe 20 has a liquid inlet 21.

The switching valve 30 is a three-way valve connected with its first opening to the liquid inlet 21 of the common liquid dispensing syringe 20, and controllable to selectively close and open its second and third openings.

The common liquid container 40 is adapted to hold a common liquid, for example, catalyst solution.

The liquid conveying channel 50 has one end connected to the common liquid container 40 and the other end connected to the second opening of the switching valve 30 for guiding the common liquid from the common liquid container 40 to the common liquid dispensing syringe 20.

The power unit 60 is interposed in the liquid conveying channel 50 at a location close to the common liquid container 40. The power unit 60 is controllable to force the common liquid out of the common liquid container 40 toward the common liquid dispensing syringe 20.

The sensor 70 is interposed in the liquid conveying channel 50 at a location close to the switching valve 30 to detect bubbles in the liquid passing through the liquid conveying channel 50. The sensor 70 outputs a signal to shut down the biochemical analyzer and to turn on an alarm (not shown) when it detects the presence of bubbles in the liquid passing through the liquid conveying channel 50.

The compressed air source 80 is connected to the third opening of the switching valve 30 and controllable to output compressed air to force residual common liquid out of the common liquid dispensing syringe 20.

The operation of the present invention is described hereinafter.

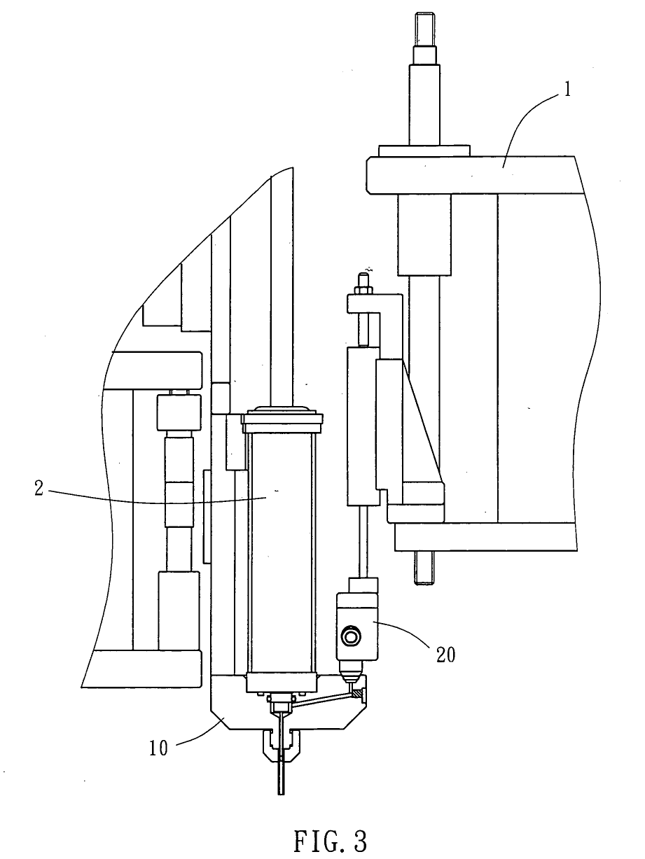

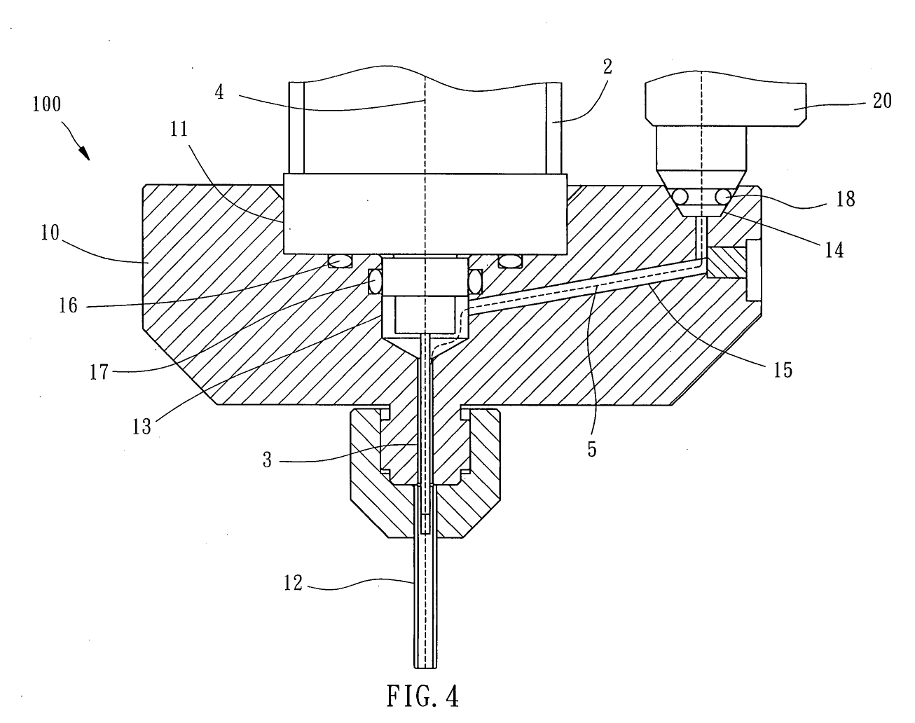

Referring to FIGS. 3 and 4, when one specific liquid dispensing syringe 2 is carried by the rotary table of the biochemical analyzer to the dispensing position, the specific liquid dispensing syringe 2 is lowered to insert its needle 3 through the first coupling hole 11 of the coupler 10 into the liquid outlet 12 and then driven to eject the contained liquid reagent 4, for example amino acid solution, 4 out of the needle 3. At the same time, the biochemical analyzer is controlled to move the common liquid dispensing syringe 20 downwards and to insert the bottom end of the common liquid dispensing syringe 20 into the second coupling hole 14 of the coupler 10, and then the power unit 60 is started to force the common liquid 5, for example the catalyst solution, out of the common liquid container 40 into the switching valve 30 through the liquid conveying channel 50, enabling the common liquid 5 to be delivered from the switching valve 30 to the liquid inlet 21 of the common liquid dispensing syringe 20 and then out of the liquid outlet 12 through the common fluid passage 15 and the connecting tunnel 13. Therefore, the invention saves much time in dispensing the common liquid 5.

After dispensation of the specific liquid reagent 4, the sensor 70 turns off the power unit 60 to stop supply of the common liquid 5 from the common liquid container 40 into the liquid conveying channel 50. Thereafter, the switching valve 30 is switched to open the passage between the compressed air source 80 and the liquid inlet 21 of the common liquid dispensing syringe 20, for enabling the compressed air source 80 to output compressed air into the liquid inlet 21 to force residual liquid out of the liquid conveying channel 50 and the coupler 10. Thereafter, the switching valve 30 is switched to open the passage between the liquid inlet 21 and the common liquid container 40, and then the specific liquid dispensing syringe 2 and the common liquid dispensing syringe 20 are detached from the coupler 10 (i.e., the dispensing syringes 2 and 20 are lifted from the coupler 10). The aforesaid procedure is repeated again and again to complete dispensing of prepared specific liquid reagents through different specific liquid dispensing syringes 2 of the biochemical analyzer and synchronous dispensing of the common liquid through the common liquid dispensing syringe 20.

What is claimed is:

1. A liquid dispensing mechanism for synchronously dispending a common liquid and a specific liquid used in a biochemical analyzer, the liquid dispending mechanism comprising:
a coupler having a first coupling hole, a liquid outlet, a connecting tunnel connected between the first coupling hole and the liquid outlet, a second coupling hole, and a common liquid passage connected between the second coupling hole and the connecting tunnel;
a specific liquid dispensing syringe containing therein a specific liquid, wherein the specific liquid dispensing syringe is insertable into the first coupling hole of the coupler for out dispensing the contained specific liquid through the liquid outlet; and
a common liquid dispensing syringe having a liquid inlet connected with a common liquid source, wherein the common liquid dispensing syringe is insertable into the second coupling hole of the coupler for dispensing the common liquid into the common liquid passage and out of the coupler through the liquid outlet of coupler together with the specific liquid.

2. The liquid dispensing mechanism as claimed in claim 1, further comprising a common liquid container containing the common liquid, and a liquid conveying channel connected between the common liquid container and the liquid inlet of the common liquid dispensing syringe for guiding the common liquid out of the common liquid container to the common liquid dispensing syringe.

3. The liquid dispensing mechanism as claimed in claim 2, further comprising a power unit interposed in the liquid conveying channel for forcing the common liquid out of the common liquid container to the common liquid dispensing syringe.

4. The liquid dispensing mechanism as claimed in claim 3, further comprising a sensor interposed in the liquid conveying channel for outputting a control signal to turn off the power unit upon detection of the presence of bubbles in the common liquid passing through the liquid conveying channel.

5. The liquid dispensing mechanism as claimed in claim 1, further comprising a compressed air source connected to the liquid inlet of the common liquid dispensing syringe for forcing residual common liquid out of the coupler.

6. The liquid dispensing mechanism as claimed in claim 1, further comprising a switching valve having a first opening connected to the liquid inlet of the common liquid dispensing syringe, a second opening connected to the common liquid source, and a third opening connected to a compressed air source; wherein the switching valve is controllable to a first operation mode where the first opening is in communication with the second opening and blocked from the third opening, and a second operation mode where the first opening is in communication with the third opening and blocked from the second opening.
